(19) United States
(12) Patent Application Publication
(10) Pub. No.: US 2025/0118811 A1
(43) Pub. Date: Apr. 10, 2025

(54) ELECTROLYTE FOR ZINC-ION BATTERY AND ZINC-ION BATTERY COMPRISING SAME

(71) Applicant: Industry-Academic Cooperation Foundation Gyeongsang National University, Jinju-si (KR)

(72) Inventor: Geon Hyoung An, Junju-si (KR)

(21) Appl. No.: 18/729,475

(22) PCT Filed: Jan. 13, 2023
(86) PCT No.: PCT/KR2023/000678

§ 371 Date: Jul. 16, 2024

(30) Foreign Application Priority Data
Jan. 20, 2022 (KR) 10-2022-0008695
Dec. 9, 2022 (KR) 10-2022-0171951

(51) Int. Cl. H01M 10/36

(52) U.S. Cl. CPC H01M 10/36; H01M 2300/0002

(57) ABSTRACT

The present invention relates to an electrolyte for a zinc-ion battery and to a zinc-ion battery comprising same. An electrolyte for a zinc-ion battery, according to one embodiment of the present invention, comprises: a zinc electrolyte; and an additive containing a manganese salt.

### TECHNICAL FIELD

The present disclosure relates to an electrolyte for a zinc-ion battery, and a zinc-ion battery including the same.

### BACKGROUND ART

The use of high-safety low-cost next-generation batteries is expected to extend from renewable energy storage and electric vehicles to portable electronic products. Commercialized lithium-ion batteries (LIBs) with high energy density are currently dominating the battery market.

LIBs are the most widely used energy storage devices. However, the use of lithium leads to poor safety, limited supply, uneven distribution, and relatively high cost.

Battery-based technologies, in particular, aqueous batteries based on Al, Mg, and Zn, which are abundant on Earth, are attracting attention because aqueous batteries are relatively inexpensive and environmentally friendly, and use safe aqueous electrolytes. Among such batteries, zinc-ion batteries (ZIBs) have attracted attention as a reasonable alternative to LIBs due to their low cost, non-toxicity, and high theoretical specific capacity of 820 mA h g⁻¹.

Nevertheless, ZIBs have limitations in that ZIBs are cathode materials with limited capacities and low rate performance due to an issue of a dissolution of manganese ions during a charging and discharging process in a cathode using manganese.

### DISCLOSURE OF THE INVENTION

### Technical Goals

To solve the above-described problems, the present disclosure provides an electrolyte additive for a zinc-ion battery, a method of manufacturing the same, and a zinc-ion battery including the same which may include an electrolyte additive, to suppress a dissolution of a manganese ion in a manganese cathode and enhance energy storage performance.

However, goals to be achieved are not limited to those described above, and other goals not mentioned above can be clearly understood by one of ordinary skill in the art from the following description.

### Technical Solutions

According to an embodiment of the present disclosure, an electrolyte for a zinc-ion battery includes a zinc electrolyte; and an additive including a manganese salt.

In an embodiment, the zinc electrolyte may include at least one selected from a group consisting of zinc sulfate (ZnSO₄), zinc chloride (ZnCl₂), zinc bromide (ZnBr₂), zinc acetate (Zn(O₂CCH₃)₂), zinc nitrate (Zn(NO₃)₂), zinc chlorate, zinc perchlorate, zinc acetate, zinc bromide, zinc trifluoromethanesulfonate, zinc bis(trifluoromethanesulfonyl) imide, and zinc hydroxide.

In an embodiment, the zinc electrolyte may have a concentration of 0.5 M to 3 M.

In an embodiment, the manganese salt may include at least one selected from a group consisting of manganese sulfate (MnSO₄), manganese carbonate (MnCO₃), manganese monoxide (MnO), manganese chloride (MnCl₂), manganese nitrate (Mn (NO₃)₂, and manganese acetate ((CH₃COO))₂Mn).

In an embodiment, the additive may have a concentration of 0.01 M to 0.5 M.

According to another embodiment of the present disclosure, a zinc-ion battery includes a cathode; an anode including zinc; a separation film disposed between the cathode and the anode; and an electrolyte for a zinc-ion battery according to an embodiment of the present disclosure filled between the cathode and the anode.

In an embodiment, the cathode may include at least one selected from a group consisting of MnO₂, Mn₃O₄, Mn₂O₃, and V₂O₅.

In an embodiment, the cathode may include a secondary particle formed by agglomerating a plurality of primary particles, the primary particles may have an average particle diameter of 20 nm to 100 nm, and the secondary particle may have an average particle diameter of 500 nm to 10 μm.

In an embodiment, the anode may include zinc, a zinc alloy with a heterogeneous element, or both.

In an embodiment, the zinc-ion battery may have a specific capacity of 200 mAh g⁻¹ to 300 mAh g⁻¹ at a current density of 0.3 A g⁻¹.

In an embodiment, the zinc-ion battery may have rate performance of 100 mAh g⁻¹ to 140 mAh g⁻¹ at a current density of 2.0 A g⁻¹.

In an embodiment, the zinc-ion battery may have a capacitance retention of 70% or greater after “200” cycles at a current density of −1.0 A g⁻¹.

### Effects of the Invention

An electrolyte for a zinc-ion battery according to an embodiment of the present disclosure may include an additive including a manganese salt, to prevent a dissolution of manganese in the electrolyte and enhance a structural stability of a cathode.

A zinc-ion battery according to an embodiment of the present disclosure may include an electrolyte for a zinc-ion battery, to solve a problem of a decrease in an amount of manganese of a cathode in a zinc-ion battery, to enhance a structural stability of the cathode and a stable cathodic reaction, thereby providing an excellent rate capability and an outstanding cycling stability.

### BRIEF DESCRIPTION OF DRAWINGS

FIG. 1A illustrates a structural collapse of a MnO₂ cathode in a ZnSO₄ electrolyte after cycling, FIG. 1B illustrates an excellent structural stability of a MnO₂ cathode in a ZnSO₄ electrolyte including a MnSO₄ additive after cycling, and FIG. 1C illustrates high performance of a zinc (Zn)-ion battery (ZIB) including a ZnSO₄ electrolyte with a MnSO₄ additive, according to an embodiment of the present disclosure.

FIG. 2 illustrates a morphological and structural characterization according to an embodiment of the present disclosure: FIG. 2A illustrates a low-magnification scanning electron microscopy (SEM) image of MnO₂, FIG. 2B illustrates a high-magnification SEM image of MnO₂, FIG. 2C illustrates an X-ray diffraction (XRD) pattern, FIG. 2D illustrates a photograph of prepared electrolytes, and FIG. 2E illustrates differential scanning calorimetry (DSC) curves.

FIG. 3A illustrates charge-discharge curves in a potential range or 1.0 V to 1.9 V at a current density of 0.3 A g⁻¹, FIG. 3B illustrates rate performance at current densities of 0.3, 0.5, 0.7, 1.0, 1.3, 1.5, 1.7, and 2.0 A g⁻¹, and FIG. 3C illustrates a cyclic stability at a current density of 1.0 A g⁻¹ for “200” cycles, according to an embodiment of the present disclosure.

FIG. 4A illustrates XRD patterns after cycling tests, and FIG. 4B illustrates a concentration of Mn in MnO₂ after the cycling tests, according to an embodiment of the present disclosure.

FIGS. 5A to 5D illustrate X-ray photoelectron spectroscopy (XPS) results for MnO₂ cathodes after cycling tests according to an embodiment of the present disclosure, and FIG. 5E illustrates a percentage of Mn⁴⁺/Mn³⁺in the MnO₂ cathodes after the cycling tests.

### BEST MODE FOR CARRYING OUT THE INVENTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Furthermore, the terms first, second, A, B, and the like, may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and duplicated descriptions will be omitted.

An electrolyte for a zinc-ion battery according to an embodiment of the present disclosure includes a zinc electrolyte; and an additive including a manganese salt.

In an embodiment of the present disclosure, the manganese salt is used as an electrolyte additive, to suppress a dissolution of manganese ions in a manganese cathode, thereby enhancing energy storage performance. In addition, a charging and discharging deterioration mechanism in a manganese cathode due to the manganese salt as an electrolyte additive has been precisely analyzed.

In an embodiment, the zinc electrolyte may include at least one selected from a group consisting of zinc sulfate (ZnSO₄), zinc chloride (ZnCl₂), zinc bromide (ZnBr₂), zinc acetate (Zn(O₂CCH₃)₂), zinc nitrate (Zn(NO₃)₂), zinc chlorate, zinc perchlorate, zinc acetate, zinc bromide, zinc trifluoromethanesulfonate, zinc bis(trifluoromethanesulfonyl) imide, and zinc hydroxide.

Desirably, the zinc electrolyte may be zinc sulfate (ZnSO₄). The zinc sulfate (ZnSO₄) has a conductivity at room temperature of about 50 mS/cm, which is less than that of an alkaline electrolyte (>400 mS/cm), and an advantage of having an extremely high reversibility of electrochemical oxidation/reduction reactions.

In an embodiment, the zinc electrolyte may have a concentration of 0.5 M to 3 M; 0.5 M to 2.5 M; 0.5 M to 2 M; 0.5 M to 1.5 M; 0.5 M to 1 M; 0.5 M to 0.8 M; 1 M to 3 M; 1 M to 2.5 M; 1 M to 2 M; 1 M to 1.5 M; 1.5 M to 3 M; 1.5 M to 2.5 M; 1.5 M to 2 M; 2 M to 3 M; 2 M to 2.5 M; or 2.5 M to 3 M.

Desirably, the zinc electrolyte may have a concentration of 1.5 M to 2.5 M.

In an embodiment, the manganese salt may include at least one selected from a group consisting of manganese sulfate (MnSO₄), manganese carbonate (MnCO₃), manganese monoxide (MnO), manganese chloride (MnCl₂), manganese nitrate (Mn (NO₃)₂, and manganese acetate ((CH₃COO))₂Mn).

Desirably, the manganese salt may be manganese sulfate (MnSO₄).

In an embodiment, the additive may have a concentration of 0.01 M to 0.5 M; 0.01 M to 0.4 M; 0.01 M to 0.3 M; 0.01 M to 0.2 M; 0.01 M to 0.1 M; 0.1 M to 0.5 M; 0.1 M to 0.4 M; 0.1 M to 0.3 M; 0.1 M to 0.2 M; 0.2 M to 0.5 M; 0.2 M to 0.4 M; 0.2 M to 0.3 M; 0.3 M to 0.5 M; 0.3 M to 0.4 M; or 0.4 M to 0.5 M.

Desirably, the additive may have a concentration of 0.1 M to 0.3 M.

Since the additive including the manganese salt is included in the electrolyte for the zinc-ion battery according to an embodiment of the present disclosure, a dissolution of manganese in the electrolyte may be prevented to enhance the structural stability of a cathode.

A zinc-ion battery according to an embodiment of the present disclosure may include an electrolyte for a zinc-ion battery, to solve a problem of a decrease in an amount of manganese of a cathode in the zinc-ion battery, and to suppress or eliminate a generation of a basic zinc sulfate hydrate, which may destroy an electrode surface structure, based on a feature that the electrolyte becomes a stronger acidic solution. In addition, an additive may enhance a structural stability of the cathode and a stable cathodic reaction, to provide excellent rate-capability and outstanding cycling stability.

A zinc-ion battery according to another embodiment of the present disclosure includes a cathode; an anode including zinc; a separation film disposed between the cathode and the anode; and an electrolyte for a zinc-ion battery according to an embodiment of the present disclosure filled between the cathode and the anode.

In an embodiment, the cathode may include at least one selected from a group consisting of MnO₂, Mn₃O₄, Mn₂O₃, and V₂O₅.

In an embodiment, the cathode may include a secondary particle formed by agglomerating a plurality of primary particles, the primary particles may have an average particle diameter of 20 nm to 100 nm, and the secondary particle may have an average particle diameter of 500 nm to 10 μm.

In an embodiment, the anode may include zinc, a zinc alloy with a heterogeneous element, or both.

In an embodiment, the heterogeneous element may include at least one selected from a group consisting of nickel (Ni), copper (Cu), iron (Fe), tungsten (W), and cobalt (Co).

Desirably, the anode may be a zinc foil.

In an embodiment, the separation film may include at least one selected from a group consisting of glass fiber, polyolefin, polyester, polytetrafluoroethylene (PTFE), polyacetal, polyamide, polyimide, polycarbonate, polyether ether ketone, polyaryletherketone, polyetherimide, polyamide-imide, polybenzimidazole, polyethersulfone, polyphenylene oxide, a cyclic olefin copolymer, polyphenylene sulfide, and polyethylene naphthalene.

Desirably, the separation film may be glass fiber.

In an embodiment, the electrolyte may be an electrolyte for a zinc-ion battery according to an embodiment of the present disclosure.

In an embodiment, the zinc-ion battery may have a specific capacity of 200 mAh g⁻¹ to 300 mAh g⁻¹ at a current density of 0.3 A g⁻¹.

In an embodiment, the zinc-ion battery may have rate performance of 100 mAh g⁻¹ to 140 mAh g⁻¹ at a current density of 2.0 A g⁻¹.

In an embodiment, the zinc-ion battery may have a capacitance retention of 70% or greater after “200” cycles at a current density of −1.0 A g⁻¹.

Since the electrolyte for the zinc-ion battery is included in the zinc-ion battery according to an embodiment of the present disclosure, a problem of a decrease in an amount of manganese of the cathode in the zinc-ion battery may be solved, and a structural stability of the cathode and a stable cathodic reaction may be enhanced, to provide an excellent rate-capability and an outstanding cycling stability.

Hereinafter, the present disclosure is described in more detail based on examples and comparative examples.

However, the following examples are only for illustrating the present disclosure, and the description of the present disclosure is not limited to the following examples.

Zinc-ion batteries (ZIBs) are considered candidates for lithium-ion batteries owing to their low cost, eco-friendly nature, and high safety level. In particular, ZIBs have a high energy density because of a two-electron transfer mechanism involving Zn ions. However, ZIBs have demerits of low rate performance and poor cycling life, because it is difficult to effectively utilize the high potential of ZIBs due to a dissolution of Mn in an electrolyte during charging and discharging. To overcome the above drawbacks, in the present disclosure, a manganese sulfate (MnSO₄) additive was introduced in an electrolyte. A ZIB with such an electrolyte exhibited a stable capacity behavior and high cycling stability. Furthermore, fabricated ZIBs showed a specific capacity of 289 mAh g⁻¹ at a current density of 0.3 A g⁻¹, improved rate performance of 116 mAh g⁻¹ at a current density of 2.0 A g⁻¹, and an excellent long-term stability of 72% for “200” cycles at a current density of 1.0 A g⁻¹. These findings indicate that the use of the manganese sulfate (MnSO₄) additive is promising for enhancing electrochemical performance of manganese-based cathodes in electrolyte-optimized next-generation ZIBs.

In an embodiment of the present disclosure, a function of a Mn²⁺additive, manganese (II) sulfate hydrate (MnSO₄), in a Zn/β-MnO₂ system was investigated. The electrochemical behavior of ZIBs and the stability of the cathode structure in ZIBs were systematically examined for different concentrations of MnSO₄ in the electrolyte. The optimized Mn²⁺additive in the electrolyte may provide excellent rate performance and outstanding cycling stability, which may be ascribed to effects of a stable cathodic reaction and a high structural stability of the cathode.

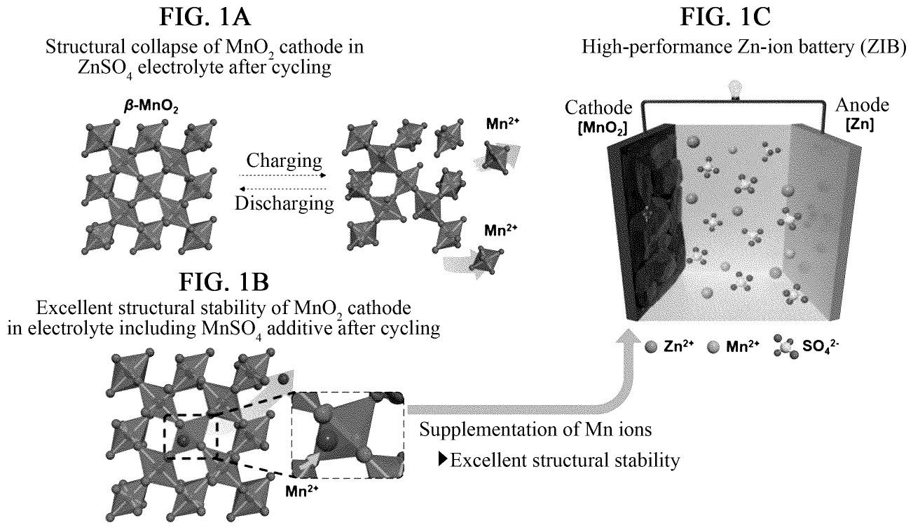

FIG. 1A illustrates a structural collapse of a MnO₂ cathode in a ZnSO₄ electrolyte after cycling, FIG. 1B illustrates an excellent structural stability of a MnO₂ cathode in a ZnSO₄ electrolyte including a MnSO₄ additive after cycling, and FIG. 1C illustrates high performance of a zinc (Zn)-ion battery (ZIB) including a ZnSO₄ electrolyte with a MnSO₄ additive, according to an embodiment of the present disclosure.

As schematically illustrated in FIG. 1A, a structure of a MnO₂ cathode in a 2.0 M ZnSO₄ electrolyte collapsed after cycling due to a dissolution of Mn in the electrolyte, which led to rapid capacity fading. A MnSO₄ additive was added to the ZnSO₄ electrolyte to improve the structural stability of the MnO₂ cathode (FIG. 1B). Finally, a ZIB was assembled using a Zn foil as an anode, a mixture of ZnSO₄ and MnSO₄ as an electrolyte, MnO₂ as a cathode, and a separation film (FIG. 1C). For an optimization of electrochemical performance of ZIBs, amounts of the MnSO₄ additive added to the 2.0 M ZnSO₄ electrolyte were 0.05 M, 0.1 M, and 0.2 M, and are hereinafter denoted by 2Zn-0.05Mn, 2Zn-0.1Mn, and 2Zn-0.2Mn, respectively. For comparison, a 2.0 M ZnSO₄ electrolyte without the MnSO₄ additive (2Zn-0Mn) was also prepared.

A surface morphology, crystalline nature, and chemical bonding states of the MnO₂ cathode were investigated via scanning electron microscopy (SEM), X-ray diffraction (XRD), and X-ray photoelectron spectroscopy (XPS). A thermal decomposition of the electrolyte was examined using differential scanning calorimetry (DSC). The energy storage performance of each electrolyte was determined using a two-electrode system that includes a Zn anode, a MnO₂ cathode, and a glass fiber as a separation film and a prepared electrolyte. Cathodes were prepared by coating a current collector with MnO₂ slurry (SigmaAldrich, Manganese (IV) oxide, No. 310700), polyvinylidene difluoride as a binder, and Ketjen Black mixed with N-methyl 2-pyrrolidine as a conductive material. The mass loading of the cathode on the current collector was ˜2.5 mg. The rate performance of ZIBs was evaluated at current densities of 0.3 to 2.0 A g⁻¹, and the cycling stability was examined at a current density of 1.0 A g⁻¹ for “200” cycles, respectively. After the cycling test, XRD and XPS analysis were performed to determine whether there were structural changes in the MnO₂ cathode. A concentration of Mn in the cathode was measured after the cycling tests by an inductively coupled plasma mass spectrometry.

### Results and Discussion

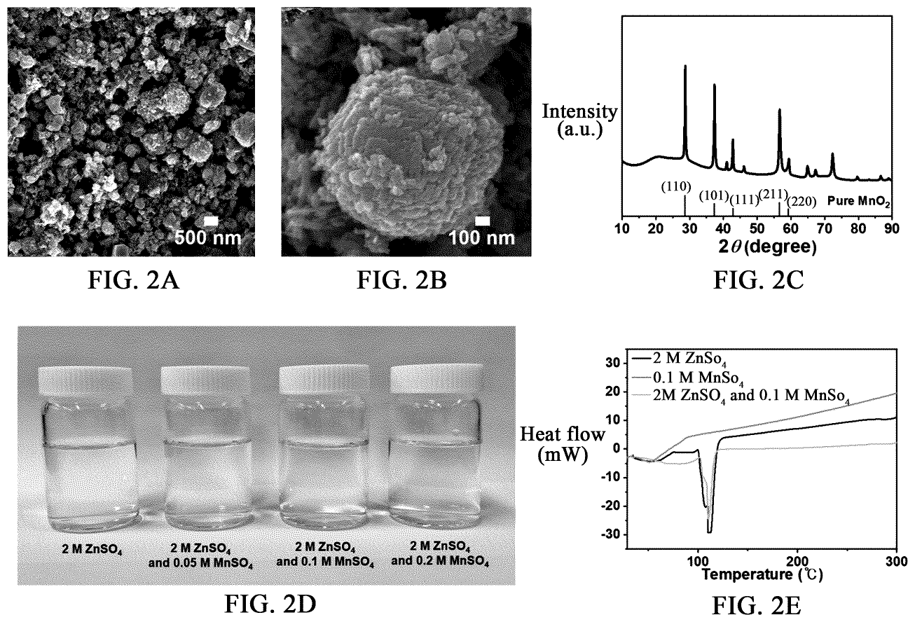

FIG. 2 illustrates a morphological and structural characterization according to an embodiment of the present disclosure: FIG. 2A illustrates a low-magnification SEM image of MnO₂, FIG. 2B illustrates a high-magnification SEM image of MnO₂, FIG. 2C illustrates an XRD pattern, FIG. 2D illustrates a photograph of prepared electrolytes, and FIG. 2E illustrates DSC curves.

The low-and high-magnification SEM images in FIGS. 2A and 2B show morphologies of MnO₂. MnO₂ powder exhibited a spherical structure including primary particles with diameters ranging from 30 to 70 nm. Due to such results, a high loading level of an electrode was expected. A crystallinity of MnO₂ was determined from the XRD image provided in FIG. 2C. Characteristic diffraction peaks of MnO₂ were observed at 28.6°, 37.3°, 42.8°, 56.6°, and 59.2°, and corresponded to a tetragonal structure of β-MnO₂. A 1×1 tunnel structure of β-MnO₂ allowed efficient Zn²⁺insertion and desertion, thereby facilitating a reversible reaction for energy storage. A photograph of 2.0 M ZnSO₄, 2.0 M ZnSO₄+0.05 M MnSO₄, 2.0 M ZnSO₄+0.1 M MnSO₄, and 2.0 M ZnSO₄+0.2 M MnSO₄ used for a preparation of electrolytes is shown in FIG. 2D. Evidently, the MnSO₄ additive was dissolved homogeneously in the electrolyte. In addition, the DSC curves in FIG. 2E show that the MnSO₄ additive did not significantly affect chemical properties of ZnSO₄. Similar endothermic peaks are observed for the 2.0 M ZnSO₄ and 2.0 M ZnSO₄+0.1 M MnSO₄ electrolytes in a temperature range of 100 to 123° C. These results show that the MnSO₄ additive is favorable in an electrochemical system.

The insertion and desertion of Zn²⁺ions into the MnO₂ cathode were further evaluated through galvanostatic charging and discharging tests in a potential range of 1.0 V to 1.9 V at a current density of 0.3 A g⁻¹. All the ZIBs showed a high Coulombic efficiency, close to 100%, indicating that the MnSO₄ additive was favorable for a reversible reaction. Similar charging and discharging profiles of all ZIBs indicated that an electrochemical insertion/extraction behavior of Zn²⁺followed the same path. A slope representing a reverse process of a Zn²⁺desertion process was monitored at a potential around 1.6 V to 1.8 V. Notably, an initial discharge capacity of 2Zn-0.1Mn and 2Zn-0.2Mn reached 289 mAh g⁻¹ and 285 mAh g⁻¹, which reached a theoretical capacity of 308 mAh g⁻¹ for MnO₂. This may be ascribed to an optimized MnSO₄ additive in an electrolyte unlocking a potential of the MnO₂ cathode.

The rate performance at various current densities in four electrolytes was also evaluated.

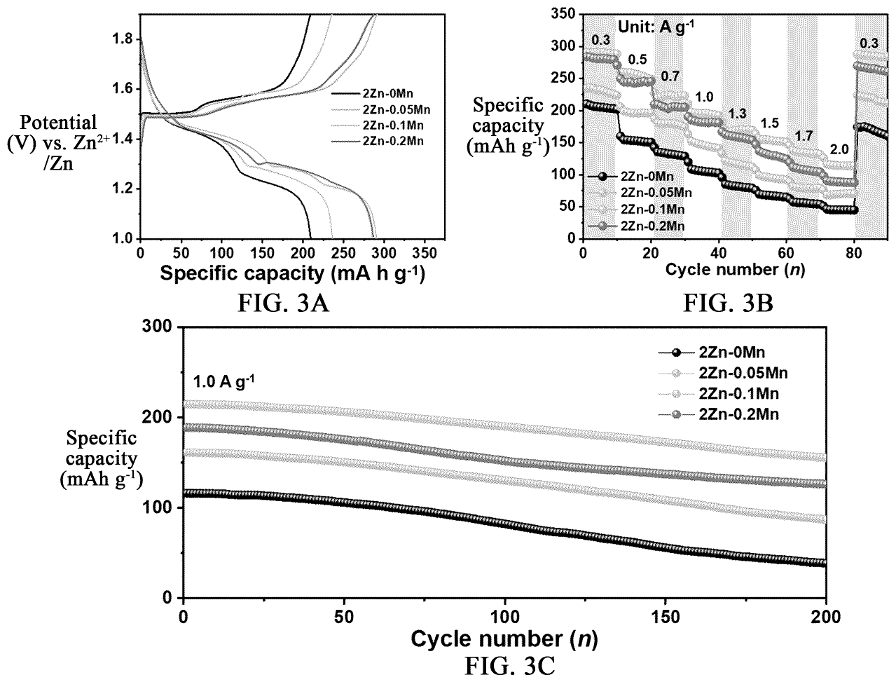

FIG. 3A illustrates charge-discharge curves in a potential range or 1.0 V to 1.9 V at a current density of 0.3 A g⁻¹, FIG. 3B illustrates rate performance at current densities of 0.3, 0.5, 0.7, 1.0, 1.3, 1.5, 1.7, and 2.0 A g⁻¹, and FIG. 3C illustrates a cyclic stability at a current density of 1.0 A g⁻¹ for “200” cycles, according to an embodiment of the present disclosure.

As shown in FIG. 3B, in comparison to the 2Zn-0Mn, 2Zn-0.05Mn, and 2Zn-0.1Mn, the electrolyte 2Zn-0.2Mn exhibited relatively high capacities at all current densities. Notably, 2Zn-0.1Mn delivered outstanding specific capacities of 289 mAh g⁻¹, 260 mAh g⁻¹, 227 mAh g⁻¹, 198 mAh g⁻¹, 169 mAh g⁻¹, 155 mAh g⁻¹, 137 mAh g⁻¹, and 116 mAh g⁻¹ at current densities of 0.3 A g⁻¹, 0.5 A g⁻¹, 0.17 A g⁻¹, 1.0 A g⁻¹, 1.3 A g⁻¹, and 2.0 A g⁻¹, respectively. When the current density recovered to 0.3 A g⁻¹, the reversible capacity may be recovered to 257 mAh g⁻¹, indicating that the 2Zn-0.1Mn possessed high rate performance. Moreover, the ZIB needs to have a long cycling stability for practical applications. Long cycling stabilities of 2Zn-0Mn, 2Zn-0.05Mn, 2Zn-0.1Mn, and 2Zn-0.2Mn at a current density of 1.0 A g⁻¹ were measured, as shown in FIG. 3C, and 2Zn-0.1Mn showed a higher specific capacity of 155 mAh g⁻¹ and higher capacity retention of 72% after “200” cycles in comparison to 2Zn-0Mn (38 mAh g⁻¹, 33%), 2Zn-0.1Mn (86 mAh g⁻¹, 53%), and 2Zn-0.2Mn (126 mAh g⁻¹, 66%). Next, to propose more insights into an influence of the MnSO4 additive in the electrolyte, a characteristic of the cathode is inquired, and a formulation of an electrochemical system is discussed.

XRD patterns of the 2Zn-0Mn, 2Zn-0.05Mn, 2Zn-0.1Mn, and 2Zn-0.2Mn cathodes were obtained after “200” cycles.

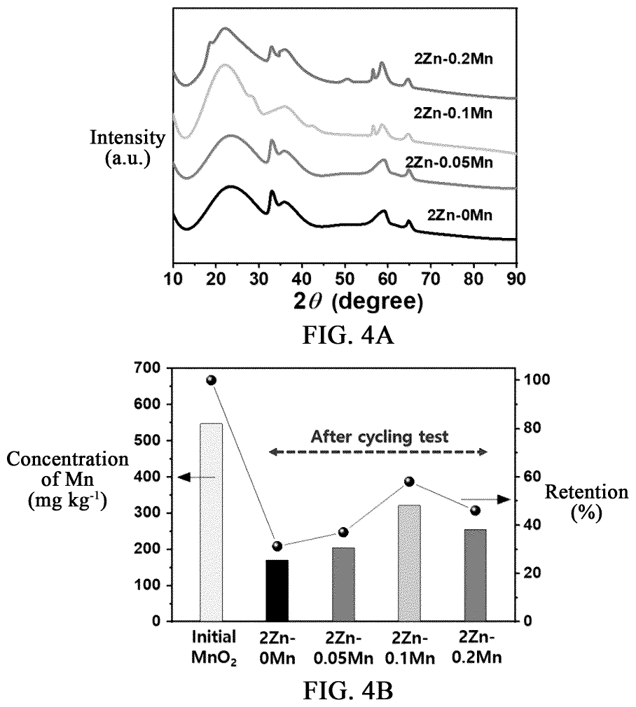

FIG. 4A illustrates XRD patterns after cycling tests, and FIG. 4B illustrates a concentration of Mn in MnO₂ after the cycling tests, according to an embodiment of the present disclosure.

In FIG. 4A, XRD patterns of the 2Zn-0Mn, 2Zn-0.05Mn, and 2Zn-0.2Mn cathodes show an irreversible reduction in a capacity due to a formation of inactive ZnMn₂O₄ in a ZIB. By contrast, an XRD pattern of the 2Zn-0.1Mn cathode did not show inactive ZnMn₂O₄ peaks, and an outstanding structural stability of the cathode is ascribed to an absence of Mn dissolution in an electrolyte during cycling, which allowed ions to be transferred across an electrode/electrolyte interface. In addition, an ICP analysis was performed to investigate a dissolution of Mn in MnO₂ in a MnO₂ cathode in the electrolyte after the cycling tests, and the results of the ICP analysis are shown in FIG. 4B. The concentration of Mn in the 2Zn-0.1Mn cathode indicated a high retention of 58% in comparison to the 2Zn-0Mn (31%), 2Zn-0.05Mn (37%), and 2Zn-0.2Mn (46%) cathodes, implying that the MnSO₄ additive in the electrolyte could effectively promote the structural stability of the cathode during cycling.

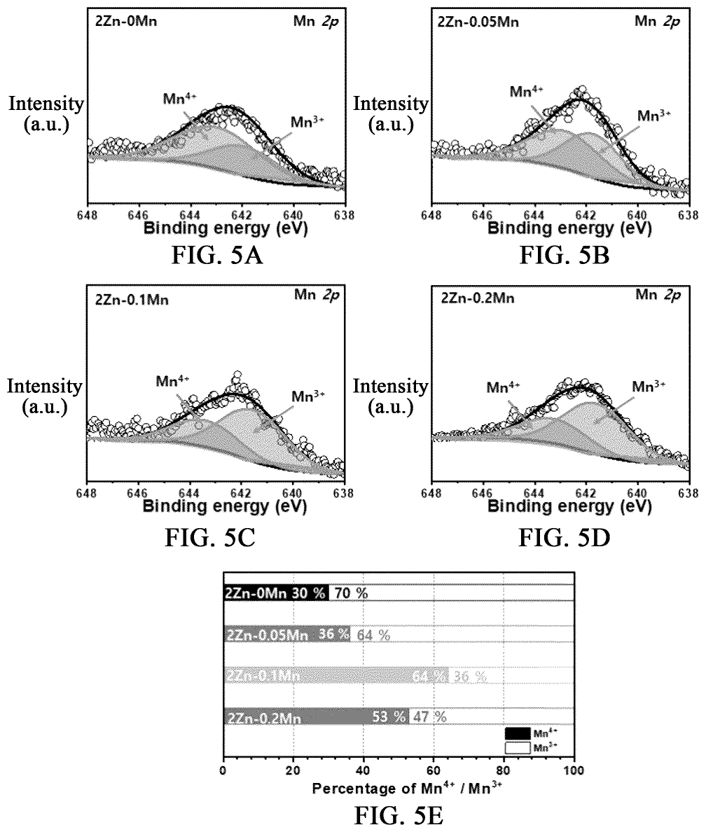

FIGS. 5A to 5D illustrate XPS results for MnO₂ cathodes after cycling tests according to an embodiment of the present disclosure, and FIG. SE illustrates a percentage of Mn⁴⁺/Mn³⁺ in the MnO₂ cathodes after the cycling tests.

Mn 2p XPS results in FIGS. 5A to 5D show a high Mn⁴⁺/Mn³⁺ ratio for a 2Zn-0.1Mn cathode after the cycling tests, in comparison to those of 2Zn-0Mn, 2Zn-0.05Mn, and 2Zn-0.2Mn cathodes. This is because of Zn2+of inactive ZnMn₂O₄ of the 2Zn-0Mn, 2Zn-0.05Mn, and 2Zn-0.2Mn cathodes. This further supports an observation of a strong potential of an optimized MnSO₄ additive in an electrolyte that was instrumental in facilitating a stable ionic diffusion. Mn³⁺/Mn⁴⁺ ratios of all ZIB cathodes are illustrated in FIG. 5E. Evidently, a 0.1 M MnSO₄ additive in the electrolyte efficiently facilitated a reversible electrochemical reaction at a MnO₂ cathode while hindering a formation of inactive ZnMn₂O₄ after cycling, to improve the rate performance and cycling stability.

### Conclusions

In an embodiment of the present disclosure, mechanisms, through which a presence of a Mn²⁺ additive in an electrolyte not only interrupts the Jahn-Teller distortion, but also improves the energy storage performance of the ZIB, were investigated. The 2Zn-0.1Mn cathode showed outstanding energy storage performance, with a superior specific capacity of 289 mAh g⁻¹ at a current density of 0.3 A g⁻¹, excellent rate performance of 116 mAh g⁻¹ at a current density of 2.0 A g⁻¹, and remarkable long-term stability of 72% for “200” cycles at a current density of 1.0 A g⁻¹.

The enhanced energy storage performance of the ZIB resulted from the improved structural stability of the MnO₂ cathode during cycling, which prevented the dissolution of Mn in the electrolyte. The present disclosure is expected to contribute to the development of (1) additives for electrolytes of ZIBs and (2) functionalized cathodes for secondary batteries using conversion reactions.

While the embodiments are described with reference to the drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. An electrolyte for a zinc-ion battery, the electrolyte comprising:
a zinc electrolyte; and
an additive comprising a manganese salt.

2. The electrolyte for the zinc-ion battery of claim 1, wherein the zinc electrolyte comprises at least one selected from a group consisting of zinc sulfate (ZnSO₄), zinc chloride (ZnCl₂), zinc bromide (ZnBr₂), zinc acetate (Zn(O₂CCH₃)₂), zinc nitrate (Zn(NO₃)₂), zinc chlorate, zinc perchlorate, zinc acetate, zinc bromide, zinc trifluoromethanesulfonate, zinc bis (trifluoromethanesulfonyl) imide, and zinc hydroxide.

3. The electrolyte for the zinc-ion battery of claim 1, wherein the zinc electrolyte has a concentration of 0.5 M to 3 M.

4. The electrolyte for the zinc-ion battery of claim 1, wherein the manganese salt comprises at least one selected from a group consisting of manganese sulfate (MnSO₄), manganese carbonate (MnCO₃), manganese monoxide (MnO), manganese chloride (MnCl₂), manganese nitrate (Mn(NO₃)₂, and manganese acetate ((CH₃COO))₂Mn).

5. The electrolyte for the zinc-ion battery of claim 1, wherein the additive has a concentration of 0.01 M to 0.5 M.

6. A zinc-ion battery comprising:
a cathode;
an anode comprising zinc;
a separation film disposed between the cathode and the anode; and
the electrolyte for the zinc-ion battery of claim 1 filled between the cathode and the anode.

7. The zinc-ion battery of claim 6, wherein the cathode comprises at least one selected from a group consisting of MnO₂, Mn₃O₄, Mn₂O₃, and V₂O₅.

8. The zinc-ion battery of claim 6, wherein
the cathode comprises a secondary particle formed by agglomerating a plurality of primary particles,
the primary particles have an average particle diameter of 20 nm to 100 nm, and
the secondary particle has an average particle diameter of 500 nm to 10 μm.

9. The zinc-ion battery of claim 6, wherein the anode comprises zinc, a zinc alloy with a heterogeneous element, or both.

10. The zinc-ion battery of claim 6, wherein the zinc-ion battery has a specific capacity of 200 mAh g⁻¹ to 300 mAh g⁻¹ at a current density of 0.3 A g⁻¹.

11. The zinc-ion battery of claim 6, wherein the zinc-ion battery has a rate performance of 100 mAh g⁻¹ to 140 mAh g−1 at a current density of 2.0 A g⁻¹.

12. The zinc-ion battery of claim 6, wherein the zinc-ion battery has a capacitance retention of 70% or greater after “200” cycles at a current density of −1.0 A g⁻¹.
